(19) United States
(12) Patent Application Publication
(10) Pub. No.: US 2026/0140760 A1
(43) Pub. Date: May 21, 2026

(54) CONTINUOUS EXECUTION OF LONG RUNNING BACKGROUND TASKS

(71) Applicant: Google LLC, Mountain View, CA (US)

(72) Inventors: Victor Carbune, Zürich (CH); Matthew Sharifi, Kilchberg (CH)

(73) Assignee: Google LLC, Mountain View, CA (US)

(21) Appl. No.: 18/948,776

(22) Filed: Nov. 15, 2024

(51) Int. Cl. G06F 9/48

(52) U.S. Cl. CPC G06F 9/4881

(57) ABSTRACT

A method includes receiving a query from a user directed toward a large language model (LLM)-powered assistant. The method also includes determining that a task specified by the query includes a time unbounded task that benefits from being continuously solved. The method also includes adding the task to a scheduling queue of multiple time unbounded tasks. Each corresponding unbounded task includes respective metadata that indicates a current performance state and triggering criteria. The method also includes executing a scheduling routine that assigns a respective priority ranking to each time unbounded task in the scheduling queue. For each corresponding time unbounded task, the method includes performing a corresponding execution event for solving the corresponding time unbounded task at a respective time based on the respective priority assigned to the corresponding time unbounded task.

### TECHNICAL FIELD

This disclosure relates to continuous execution of long running background tasks.

### BACKGROUND

Large language models (LLMs) are increasingly used to provide conversational experiences between users and digital assistant interfaces executing on user devices. In general, a user provides a query/prompt to the LLM in natural language that requests information and the LLM generates, based on the query/prompt, a response conveying the requested information. As LLMs are currently opening up a wide range of applications due to their powerful understanding and generation capabilities which can operate over text, image, and/or audio inputs, LLMs are becoming customized to operate and provide specific services for users. However, LLMs are still incapable of handling some queries due to LLMs being constrained to fulfilling performance of queries within a predetermined amount of time and/or using a predetermined amount of computing resources.

### SUMMARY

One aspect of the disclosure provides a computer-implemented method executing on data processing hardware that causes the data processing hardware to perform operations for executing long running background tasks. The operations include receiving a query from a user directed toward a large language model (LLM)-powered assistant. The query specifies a task for the LLM-powered assistant to solve on behalf of the user. The operations also include determining that the task specified by the query includes a time unbounded task that benefits from being continuously solved during ongoing execution events performed by the LLM-powered assistant. The operations also include adding the task to a scheduling queue of multiple time unbounded tasks based on determining that the task specified by the query includes the time unbounded task. Each corresponding time unbounded task among the multiple time unbounded tasks in the scheduling queue includes respective metadata that indicates a current performance state of the corresponding time unbounded task performed by the LLM-powered assistant and triggering criteria allocated to the corresponding time unbounded task that indicates when and/or how often the LLM-powered assistant is to perform execution events for solving the corresponding time unbounded task. The operations also include executing a scheduling routine that assigns a respective priority ranking to each time unbounded task in the scheduling queue by processing the respective metadata. For each corresponding time unbounded task of the multiple time unbounded tasks in the scheduling queue, the operations include performing, by the LLM-powered assistant, a corresponding execution event for solving the corresponding time unbounded task at a respective time based on the respective priority assigned to the corresponding time unbounded task to obtain a new performance state of the corresponding time unbounded task.

Implementations of the disclosure may include one or more of the following optional features. In some implementations, the operations further include, in response to receiving the query: obtaining initial results responsive to an initial attempt by the LLM-powered assistant to solve the task specified by the query and serving the initial results to the user, and receiving user feedback indicating that the user would like the LLM-powered assistant to better solve the task specified by the query without specifying any time bound to solve the task after serving the initial results to the user. Here, determining that the task specified by the query includes the time unbounded task based on the received user feedback. The operations may further include processing, by the LLM-powered assistant, the task specified by the query to predict a code function useful for triggering the LLM-powered assistant to perform an execution event for solving the task after adding the task to the scheduling queue of the multiple time unbounded tasks, attaching the predicted code script to the respective metadata of the task added to the scheduling queue, executing the code script to check whether content relevant to solving the task becomes available at one or more external content sources, and re-executing the scheduling routine to assign a new priority ranking to the task in the scheduling queue when the content relevant to solving the task becomes available at one of the one or more external content sources.

In some examples, after performing the corresponding execution event for solving the corresponding time unbounded task to obtain the new performance state, the operations further include determining whether the new performance state obtained for the corresponding time unbounded task indicates that the LLM-powered assistant has reached a state of completion for solving the corresponding time unbounded task and, when the new performance state indicates that the LLM-powered assistant has not reached the state of completion for solving the corresponding time unbounded task, updating the respective metadata for the corresponding time unbounded task in the scheduling queue to designate the new performance state obtained for the corresponding time unbounded task as the current performance state and re-executing the scheduling routine to assign a new respective priority ranking to the corresponding time unbounded task in the scheduling queue by processing the respective metadata. Here, updating the respective metadata may further include updating the respective metadata for the corresponding time unbounded task to include new triggering criteria allocated to the corresponding unbounded task based on the new performance state obtained for the corresponding time unbounded task. In these examples, when the new performance state indicates that the LLM-powered assistant has not reached the state of completion, the operations may further include processing the new performance state to estimate how close the corresponding time unbounded task is to reaching the state of completion and identifying, by the LLM-powered assistant, one or more types of additional execution events to perform to achieve improvements to the new performance event based on the current performance state of the corresponding time unbounded task and the estimated closeness of the corresponding time unbounded task to reaching the state of completion. Here, processing the new performance state to estimate how close the corresponding time unbounded task is to reaching the state of completion includes structuring a natural language prompt to solicit a response from the LLM-powered assistant that indicates a level of completeness of the corresponding unbounded task and processing, using the LLM-powered assistant, the natural language prompt conditioned on the new performance state to determine the level of completeness of the corresponding time unbounded task. When the new performance state indicates that the LLM-powered assistant has not reached the state of completion, the operations may further include determining that it would be beneficial to solicit additional information from the user regarding the new performance state of the corresponding time unbounded task based on the new performance state, issuing a notification to the user indicating the new performance state of the corresponding time unbounded task and soliciting the user to provide the additional information regarding the new performance state of the corresponding time unbounded task, receiving the additional information from the user regarding the new performance state of the corresponding unbounded task, and performing, by the LLM-powered assistant, another corresponding execution event for solving the corresponding time unbounded task to update the new performance state by the LLM-powered assistant.

In some implementations, the respective metadata further indicates time-stamped data obtained by the LLM-powered assistant during one or more previous execution events of the corresponding time unbounded task performed by the LLM-powered assistant. The operations may further include receiving contextual information related to the user and/or one or more external events associated with at least one of the time unbounded tasks in the scheduling queue of the multiple time unbounded tasks and re-executing the scheduling routine to update the respective priority ranking assigned to each time unbounded task in the scheduling queue based on the received contextual information. In some examples, after performing the corresponding execution event to obtain the new performance state for a corresponding one of the multiple time unbounded tasks in the scheduling queue, the operations further include determining that the new performance state for the corresponding one of the multiple time unbounded tasks effects the current performance state of a corresponding other one of the multiple time unbounded tasks in the scheduling queue and updating at least one of the current performance state or the triggering criteria indicated by the respective metadata for the corresponding other one of the multiple time unbounded tasks in the scheduling queue based on determining that the new performance state for the corresponding one of the multiple time unbounded tasks effects the current performance state of the corresponding other one of the multiple time unbounded tasks in the scheduling queue. In these examples, the operations may further include providing a notification to the user that indicates that the at least one of the current performance state or the triggering criteria indicated by the respective metadata for the corresponding other one of the multiple time unbounded tasks in the scheduling queue has been updated.

Another aspect of the disclosure provides a system that includes data processing hardware and memory hardware storing instructions that when executed on the data processing hardware causes the data processing hardware to perform operations. The operations include receiving a query from a user directed toward a large language model (LLM)-powered assistant. The query specifies a task for the LLM-powered assistant to solve on behalf of the user. The operations also include determining that the task specified by the query includes a time unbounded task that benefits from being continuously solved during ongoing execution events performed by the LLM-powered assistant. The operations also include adding the task to a scheduling queue of multiple time unbounded tasks based on determining that the task specified by the query includes the time unbounded task. Each corresponding time unbounded task among the multiple time unbounded tasks in the scheduling queue includes respective metadata that indicates a current performance state of the corresponding time unbounded task performed by the LLM-powered assistant and triggering criteria allocated to the corresponding time unbounded task that indicates when and/or how often the LLM-powered assistant is to perform execution events for solving the corresponding time unbounded task. The operations also include executing a scheduling routine that assigns a respective priority ranking to each time unbounded task in the scheduling queue by processing the respective metadata. For each corresponding time unbounded task of the multiple time unbounded tasks in the scheduling queue, the operations include performing, by the LLM-powered assistant, a corresponding execution event for solving the corresponding time unbounded task at a respective time based on the respective priority assigned to the corresponding time unbounded task to obtain a new performance state of the corresponding time unbounded task.

Implementations of the disclosure may include one or more of the following optional features. In some implementations, the operations further include, in response to receiving the query: obtaining initial results responsive to an initial attempt by the LLM-powered assistant to solve the task specified by the query and serving the initial results to the user, and receiving user feedback indicating that the user would like the LLM-powered assistant to better solve the task specified by the query without specifying any time bound to solve the task after serving the initial results to the user. Here, determining that the task specified by the query includes the time unbounded task based on the received user feedback. The operations may further include processing, by the LLM-powered assistant, the task specified by the query to predict a code function useful for triggering the LLM-powered assistant to perform an execution event for solving the task after adding the task to the scheduling queue of the multiple time unbounded tasks, attaching the predicted code script to the respective metadata of the task added to the scheduling queue, executing the code script to check whether content relevant to solving the task becomes available at one or more external content sources, and re-executing the scheduling routine to assign a new priority ranking to the task in the scheduling queue when the content relevant to solving the task becomes available at one of the one or more external content sources.

In some examples, after performing the corresponding execution event for solving the corresponding time unbounded task to obtain the new performance state, the operations further include determining whether the new performance state obtained for the corresponding time unbounded task indicates that the LLM-powered assistant has reached a state of completion for solving the corresponding time unbounded task and, when the new performance state indicates that the LLM-powered assistant has not reached the state of completion for solving the corresponding time unbounded task, updating the respective metadata for the corresponding time unbounded task in the scheduling queue to designate the new performance state obtained for the corresponding time unbounded task as the current performance state and re-executing the scheduling routine to assign a new respective priority ranking to the corresponding time unbounded task in the scheduling queue by processing the respective metadata. Here, updating the respective metadata may further include updating the respective metadata for the corresponding time unbounded task to include new triggering criteria allocated to the corresponding unbounded task based on the new performance state obtained for the corresponding time unbounded task. In these examples, when the new performance state indicates that the LLM-powered assistant has not reached the state of completion, the operations may further include processing the new performance state to estimate how close the corresponding time unbounded task is to reaching the state of completion and identifying, by the LLM-powered assistant, one or more types of additional execution events to perform to achieve improvements to the new performance event based on the current performance state of the corresponding time unbounded task and the estimated closeness of the corresponding time unbounded task to reaching the state of completion. Here, processing the new performance state to estimate how close the corresponding time unbounded task is to reaching the state of completion includes structuring a natural language prompt to solicit a response from the LLM-powered assistant that indicates a level of completeness of the corresponding unbounded task and processing, using the LLM-powered assistant, the natural language prompt conditioned on the new performance state to determine the level of completeness of the corresponding time unbounded task. When the new performance state indicates that the LLM-powered assistant has not reached the state of completion, the operations may further include determining that it would be beneficial to solicit additional information from the user regarding the new performance state of the corresponding time unbounded task based on the new performance state, issuing a notification to the user indicating the new performance state of the corresponding time unbounded task and soliciting the user to provide the additional information regarding the new performance state of the corresponding time unbounded task, receiving the additional information from the user regarding the new performance state of the corresponding unbounded task, and performing, by the LLM-powered assistant, another corresponding execution event for solving the corresponding time unbounded task to update the new performance state by the LLM-powered assistant.

In some implementations, the respective metadata further indicates time-stamped data obtained by the LLM-powered assistant during one or more previous execution events of the corresponding time unbounded task performed by the LLM-powered assistant. The operations may further include receiving contextual information related to the user and/or one or more external events associated with at least one of the time unbounded tasks in the scheduling queue of the multiple time unbounded tasks and re-executing the scheduling routine to update the respective priority ranking assigned to each time unbounded task in the scheduling queue based on the received contextual information. In some examples, after performing the corresponding execution event to obtain the new performance state for a corresponding one of the multiple time unbounded tasks in the scheduling queue, the operations further include determining that the new performance state for the corresponding one of the multiple time unbounded tasks effects the current performance state of a corresponding other one of the multiple time unbounded tasks in the scheduling queue and updating at least one of the current performance state or the triggering criteria indicated by the respective metadata for the corresponding other one of the multiple time unbounded tasks in the scheduling queue based on determining that the new performance state for the corresponding one of the multiple time unbounded tasks effects the current performance state of the corresponding other one of the multiple time unbounded tasks in the scheduling queue. In these examples, the operations may further include providing a notification to the user that indicates that the at least one of the current performance state or the triggering criteria indicated by the respective metadata for the corresponding other one of the multiple time unbounded tasks in the scheduling queue has been updated.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system of executing long running background tasks.

FIG. 2 is a schematic view of an example scheduler of a task management system.

FIG. 3 is a flowchart of an example arrangement of operations for a computer-implemented method of executing long running background tasks.

FIG. 4 is a schematic view of an example computing device that may be used to implement the systems and methods described herein.

Like reference symbols in the various drawings indicate like elements.

### DETAILED DESCRIPTION

Large language models (LLMs) are capable of performing actions or tasks specified by queries. For instance, LLMs may generate natural language responses to various types of queries ranging from simple factual questions to complex problem-solving tasks. For some tasks, users may issue queries that require the LLM to first create a plan for solving the task, and then execute the plan step by step and present the results to the user in some form. However, LLMs are currently configured to perform one-shot or time-bounded queries whereby the LLMs are constrained to provide an answer using a fixed amount of computing resources and/or within a fixed time frame.

These constraints may limit LLMs from generating an optimal response for queries that require more computational resources and/or more time to adequately respond to such queries.

Accordingly, implementations herein are directed towards a task manager or task management system that manages execution of long running background tasks. The task manager receives a query from a user directed toward a LLM-powered assistant that specifies a task to solve on behalf of the user. The task manager determines that the task specified by the query includes a time unbounded task that benefits from being continuously solved during ongoing execution events performed by the LLM-powered assistant. The task manager adds the task to a scheduling queue of multiple time unbounded tasks based on determining that the task specified by the query includes the time unbounded task. Each corresponding time unbounded task in the scheduling queue has respective metadata that indicates a current performance state of the corresponding time unbounded task performed by the LLM-powered assistant and triggering criteria allocated to the corresponding time unbounded task that indicates when and/or how often the LLM-powered assistant is to perform execution events for solving the corresponding time unbounded task. The task manager executes a scheduling routine that assigns a respective priority ranking to each time unbounded task in the scheduling queue by processing the respective metadata. For each corresponding time unbounded task of the multiple time unbounded tasks in the scheduling queue, the LLM-powered assistant performs a corresponding execution event for solving the corresponding time unbounded task at a respective time based on the respective priority assigned to the corresponding time unbounded task to obtain a new performance state of the corresponding time unbounded task.

Advantageously, by assigning priority rankings to each time unbounded task in the scheduling queue by processing the metadata (i.e., current performance state and triggering criteria) and performing corresponding execution events based on the respective priority ranking assigned to the time unbounded tasks, the task manager is able to efficiently and effectively manage the execution of long running background tasks. In particular, the task manager is able to prioritize the LLM-powered assistant to execute execution events for corresponding time unbounded tasks assigned a higher respective priority ranking. Moreover, by performing ongoing execution events for the time unbounded tasks, the LLM-powered assistant is able to leverage dynamic changes in available data to continuously provide up to date responses to such time unbounded tasks.

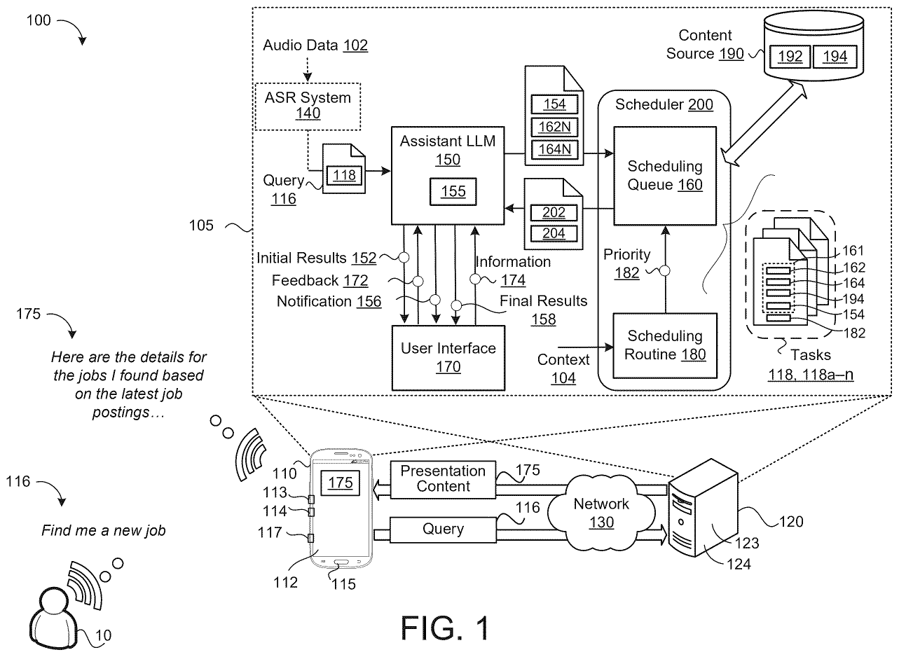

FIG. 1 illustrates an example system 100 including a task management system 105 that allows users 10 to interact with a large language model (LLM)-powered assistant 150 to perform actions on behalf of the user 10. Generally, the user 10 inputs, via a user device 110, a natural language query 116 specifying a task to be performed or solved on behalf of the user 10. Here, the LLM-powered assistant 150 may process the natural language query 116 by performing query interpretation to ascertain the particular action to be performed. Solving the task or fulfillment of the action may require performance of multiple portions, or sub-actions/tasks, that collectively define the particular action. The LLM-powered assistant 150 is configured to provide, for output from the user device 110, presentation content 175 which may include initial results 152 and/or final results 158. The user device 110 may audibly output, from an audio output device (e.g., acoustic speaker) 117, the presentation content 175 as synthesized speech. Additionally or alternatively, the user device 110 may display, on a screen 112 in communication with the user device 110, graphics, text, and/or other visual information that conveys the details of the presentation content 175.

The system 100 includes the user device 110, a remote computing system 120, and a network 130. The user device 110 includes data processing hardware 113 and memory hardware 114. The user device 110 may include, or be in communication with, and audio capture device 115 (e.g., an array of one or more microphones) for converting utterances of natural language queries 116 spoken by the user 10 into corresponding audio data 102 (e.g., electrical signals or digital data). In lieu of spoken input, the user 10 may input a textual representation of the natural language query 116 via a user interface 170 executing on the user device 110. In scenarios when the user 10 speaks a natural language query 116 captured by the microphone 115 of the user device 110, an automated speech recognition (ASR) 140 executing on the user device 110 or the remote computing system 120 may process the corresponding audio data 102 to generate a transcription of the query 116. Here, the transcription conveys the natural language query 116 as a textual representation for input to the LLM-powered assistant 150. The ASR system 140 may implement any number and/or type(s) of past, current, or future speech recognition systems, models, and/or methods including, but not limited to, an end-to-end speech recognition model, such as streaming speech recognition models having recurrent neural network-transducer (RNN-T) model architectures, a hidden Markov model, an acoustic model, a pronunciation model, a language model, and/or a naïve Bayes classifier.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the task management system 105 includes the ASR system 140, the LLM-powered assistant 150, and the user interface 170. The ASR system 140 may be optional or only leveraged when the user 10 prefers spoken input of natural language queries 116 as opposed to typed input. In some implementations, the task management system 105 executes on both the data processing hardware 113 of the user device 110 and the data processing hardware 123 of the remote computing system 120. For instance, one or more components of the task management system 105 may execute on the data processing hardware 113 of the user device 110 while one or more other components of the task management system 105 may execute on the remote computing system 120.

In some implementations, the LLM-powered assistant 150 is personalized for the user 10. The LLM-powered assistant 150 may function as a personal chatbot capable of having dialog conversations with the user 10 in natural language and performing tasks/actions or solving tasks/actions on behalf of the user 10. In some examples, the LLM-powered assistant 150 includes an instance of Bard, LaMDA, BERT, Meena, GPT, or any other previously trained LLM. These previously trained LLMs have been trained on enormous amounts of diverse data and are capable of engaging in corresponding with users 10 in a natural and intuitive manner. However, these LLMs have a plurality of machine learning (ML) layers and hundreds of millions to hundreds of billions of ML parameters. Accordingly, in implementations where the LLM-powered assistant 150 is an instance of a previously-trained LLM fine-tuned locally at the user device 110, the previously trained LLM that is obtained and fine-tuned to provide the LLM-powered assistant 150 personalized for the user 10 may be a sparsified version of the previously trained LLM. In contrast, in implementations where the LLM-powered assistant 150 is an instance of the previously-trained LLM fine-tuned remotely from the user device 110, the previously trained LLM is obtained and fine-tuned to provide the LLM-powered assistant 150 may be a dense version of the previously trained LLM. The sparsified version of the previously trained LLM may have fewer ML layers, fewer ML parameters, masked weights, and/or other sparsified aspects to reduce the size of the previously trained LLM due to various hardware constraints and/or software constraints at the user device 110 compared to the virtually limitless resources of the remote computing system 120.

The LLM-powered assistant 150 allows unstructured free-form natural language input that conveys the details of the actions/tasks to be performed but does not define any corresponding dialog state map (e.g., does not define any dialog states or any dialog state transitions). In response to receiving the query 116 as the unstructured free-form natural language input, the LLM-powered assistant 150 performs the action/task specified by the query 116 on behalf of the user 10. The LLM-powered assistant 150 may determine presentation content 175 based on performing or solving the action/task specified by the query 116. The presentation content 175 may include, for example, a corresponding result of one or more tasks performed by the LLM-powered assistant 150, a corresponding summary of the corresponding tasks, and/or other content. In some configurations, the LLM-powered assistant 150 performs tasks/actions, or portions thereof, on behalf of the user 10 by interacting with one or more specialized LLMs.

Here, each of the one or more specialized LLMs may be trained, fine-tuned, or conditioned on particular prompts to specialize the LLM to perform particular types of tasks.

In some examples, the LLM-powered assistant 150 processes the task 118 specified by the query 116 to generate initial results 152 responsive to an initial attempt by the LLM-powered assistant 150 to solve the task 118 specified by the query 116. The initial results 152 may be results that the LLM-powered assistant 150 was able to generate within a predetermined amount of time or with a predetermined amount of computing resources. The LLM-powered assistant 150 serves the initial results 152 to the user 10 by presenting the initial results 152 via the user interface 170 and/or synthesizing audio of the initial results 152 as output from the user device 110.

After serving or providing the initial results 152 to the user 10, the LLM-powered assistant 150 may receive user feedback 172 indicating that the user 10 would like the LLM-powered assistant 150 to better solve the task 118 specified by the query 116 without specifying any time bound to solve the task 118. The user feedback 172 may be an utterance spoken by the user 10 and transcribed by the ASR system 140 or a textual input provided by the user 10. For example, the query 116 may specify the task 118 of “find me a new job” whereby the LLM-powered assistant 150 processes the query 116 to generate the initial results 152 including an initial list of job openings. In this example, the user 10 may respond with the user feedback 172 of “please keep looking” indicating that the user 10 wants the task 118 to be better solved without a time bound in mind. The task management system 105 may also determine one or more execution events 155 and/or update triggering criteria 174 for the corresponding task 118 based on the user feedback 172.

Notably, time unbounded tasks are tasks 118 that benefit from being continuously solved during ongoing execution events performed by the LLM-powered assistant 150. That is, a time unbounded task refers to a type of task that does not have a predefined end boundary and may execute indefinitely in the background. Unlike one-shot or single-shot queries, which require an immediate response, or time-bounded tasks, which have a specific deadline or computational resource budget, time unbounded tasks are configured to continuously operate and improve over time or operate until a satisfactory result is produced. Time unbounded tasks are particularly useful for scenarios where ongoing monitoring and refinement are beneficial, such as “find me a job” or “find me a flat.” In contrast to one-shot or single-shot queries, time unbounded tasks may leverage additional compute time and/or computing resources allocated to the LLM-powered assistant 150 to not only refine the output but also react to changes in the external environment. This adaptability is particularly beneficial for tasks that are not tied to a specific deadline or specific amount of computing resources. For instance, the results for a query 116 regarding switching jobs is contingent upon the availability of opportunities, and results for a query 116 regarding purchasing a discounted product depends on market timing. Here, a single-shot query may simply provide results regarding available job opportunities or current product pricing at the time the query 116 was received. In contrast, a time unbounded task enables the LLM-powered assistant 150 to continuously execute the task 118 to provide updated results.

In some examples, the LLM-powered assistant 150 determines that the task 118 specified by the query 116 includes the time unbounded task 118 by performing query interpretation (e.g., natural language understanding) on the query 116. Here, the LLM-powered assistant 150 may determine that the task 118 specified by the query 116 includes the time unbounded task 118 without receiving any subsequent input from the user 10 after receiving the query 116. That is, the LLM-powered assistant 150 may determine that the task 118 specified by the query 116 includes the time unbounded task without generating the initial results 152 or receiving the user feedback 172 from the user 10. Based on determining that the task 118 specified by the query 116 includes the time unbounded task 118 (e.g., by processing the query 116 itself or receiving the user feedback 172), the LLM-powered assistant 150 sends the time unbounded task 118 to a scheduler 200. The scheduler 200 includes a scheduling queue 160 and a scheduling routine 180 whereby the scheduler 200 adds the task 118 to the scheduling queue 160 based on determining that the task 118 includes the time unbounded task 118. Here, the scheduling queue 160 includes multiple time unbounded tasks 118, 118a-n.

Each corresponding time unbounded task 118 among the multiple time unbounded tasks 118 in the scheduling queue 160 includes respective metadata 161. The respective metadata 161 of each corresponding time unbounded task 118 indicates a current performance state 162 of the corresponding time unbounded task 118 and triggering criteria 164 of the corresponding time unbounded task 118. The current performance state 162 indicates a status of ongoing execution events 155 performed by the LLM-powered assistant 150 for the corresponding time unbounded task 118. Moreover, the current performance state 162 may include data associated with one or more previously executed execution events 155 such that the LLM-powered assistant 150 continues performance of the time unbounded task 118 from where the previous execution events 155 left off. The triggering criteria 164 indicates when and/or how often the LLM-powered assistant 150 is to perform execution events 155 for solving the corresponding time unbounded task 118. For example, the triggering criteria 164 may define one or more changes in certain content sources to cause a respective execution event 155 of a corresponding time unbounded task 118 to execute again. In another example, the triggering criteria 164 may define a predetermined time interval such that a respective execution event 155 of the corresponding time unbounded task 118 executes at each predetermined time interval.

In some examples, the respective metadata 161 of each corresponding time unbounded task 118 further indicates time-stamped data 194 obtained by the LLM-powered assistant 150 or the scheduler 200 during one or more previous execution events 155 of the corresponding time unbounded task 118 performed by the LLM-powered assistant 150. Here, the scheduler 200 may obtain the time-stamped data 194 from one or more external content sources 190. The time-stamped data 194 may indicate data associated with a previously executed execution event 155 such that the LLM-powered assistant 150 may leverage the time-stamped data 194 in the respective metadata 161 when executing subsequent time unbounded tasks 118.

The scheduler 200 executes the scheduling routine 180 that assigns a respective priority ranking 182 to each corresponding time unbounded task 118 in the scheduling queue 160 by processing the respective metadata 161 of each corresponding time unbounded task 118 in the scheduling queue 160. For each corresponding time unbounded task 118 of the multiple time unbounded tasks 118 in the scheduling queue, the LLM-powered assistant 150 performs a corresponding execution event 155 for solving the corresponding time unbounded task 118 at a respective time based on the respective priority ranking 182 assigned to the corresponding time unbounded task 118 to obtain a new performance state 162, 162N and/or new triggering criteria 164, 164N of the corresponding time unbounded task 118.

The priority rankings 182 assigned to the time unbounded tasks 118 indicate to the LLM-powered assistant 150 how to prioritize execution of the time unbounded tasks 118. Put another way, the LLM-powered assistant 150 utilizes the priority rankings 182 to efficiently manage and schedule the execution of the time unbounded tasks 118 thereby ensuring that higher-priority tasks are addressed or executed before those of lower priority. As will become apparent, the scheduler 200 dynamically updates the priority rankings 182 as new time unbounded tasks 118 are added to the scheduling queue 160 or as the metadata 161 of the existing time unbounded tasks 118 changes. This dynamic updating allows the LLM-powered assistant 150 to adapt to evolving metadata 161 and maintain optimal task execution order.

In some examples, the scheduler 200 receives contextual information (also referred to as ‘context’) 104 related to the user 10 and/or one or more external events associated with at least one of the time unbounded tasks 118 in the scheduling queue 160 of the multiple time unbounded tasks 118. Based on receiving the contextual information 104, the scheduler 200 may re-execute the scheduling routine 180 to update the respective priority ranking 182 ranking assigned to each time unbounded task 118 in the scheduling queue 160. For example, the scheduler 200 may receive the contextual information 104 indicating that the user 10 found a new job for the corresponding time unbounded task 118 of “find me a new job.” In this example, the scheduler may re-execute the scheduling routine 180 to assign a lower priority ranking to the corresponding time unbounded task 118 of “find me a new job” or drop the corresponding time unbounded task 188 from the scheduling queue 160 altogether. In some examples, the contextual information 104 includes information derived by one or more actions performed by the user 10. For instance, the contextual information 104 may indicate salary expectations that the user 10 input while interacting with a web-page or the LLM-powered assistant 150. As such, the scheduler 200 may re-execute the scheduling routine based on the contextual information 104.

In some implementations, the LLM-powered assistant 150 processes the task 118 specified by the query 116 to predict a code script 154 useful for triggering the LLM-powered assistant 150 to perform an execution event 155 for solving the task 118. The LLM-powered assistant 150 may predict the code function (i.e., code script) 154 before adding the task 118 to the scheduling queue 160 or after adding the task 118 to the scheduling queue 160. The scheduler 200 attaches the predicted code script 154 to check whether content 192 relevant to solving the task 118 becomes available at one or more external content sources 190. That is, execution of the code script 154 causes the task management system 105 to determine whether new content 192 relevant to solving the task 118 becomes available. Continuing with the example above, the code script 154, when executed, may cause the scheduler 200 to identify new content 192 from the content source 190, such as a new job posting from a job posting site and re-execute the scheduling routine to assign a new priority ranking 182 to the task 118 in the scheduling queue based on the new content 192. Here, the scheduler 200 may determine whether the new content 192 is relevant to any of the tasks 118 in the scheduling queue 160 before re-executing the scheduling routine 180.

The code script 154 may include user interface automation scripts that check web pages for updated data or application programming interface calls that pull new data from the content sources 190 and update stale data. Notably, the task management system 105 may execute the code script 154 with or without using the LLM-powered assistant 150. When the content relevant to solving the task 118 becomes available at one of the one or more external content sources 190, the task management system 105 re-executes the scheduling routine 180 to assign a new priority ranking 182 to the task 118 in the scheduling queue 160. Otherwise, when no new content relevant to solving the task 118 is available at one of the one or more external content sources 190, the task management system 105 may refrain from re-executing the scheduling routine 180.

After the LLM-powered assistant 150 performs the corresponding execution event 155 for solving the corresponding time unbounded task 118 to obtain the new performance state 162N, the scheduler 200 determines whether the new performance state 162N obtained for the corresponding time unbounded task 118 indicates that the LLM-powered assistant 150 has reached a state of completion for solving the corresponding time unbounded task 118. In some examples, when the new performance state 162N indicates that the LLM-powered assistant 150 has not reached the state of completion, the task management system 105 determines that it would be beneficial to solicit additional information 174 from the user 10 regarding the new performance state 162N of the corresponding time unbounded task 118. As such, the LLM-powered assistant 150 may issue a notification 156 to the user 10 that indicates the new performance state 162N of the corresponding time unbounded task 118 and solicit the user 10 to provide the additional information 174 regarding the new performance state 162N of the corresponding time unbounded task 118. Thereafter, the LLM-powered assistant 150 may receive the additional information 174 from the user 10 regarding the new performance state 162N of the corresponding unbounded task 118 and perform another execution event 155 for solving the corresponding time unbounded task 118 to update the new performance state 162N. Here, the additional information 174 may include the user feedback 172 or include different information.

For example, the new performance state 162N may indicate that the LLM-powered assistant 150 has not reached the state of completion for the task of “find me a new job,” whereby the task management system 105 determines that it would be beneficial to solicit additional information 174 from the user 10 regarding the new performance state 162N indicating one or more potential new jobs found by the LLM-powered assistant 150. In this example, the additional information 174 solicited by the LLM-powered assistant 150 may include, “do any of the following jobs look interesting to you?” for which the user 10 provides a response to. If the user 10 responded “no,” the LLM-powered assistant may perform another corresponding execution event 155 that finds one or more additional jobs not previously presented to the user 10.

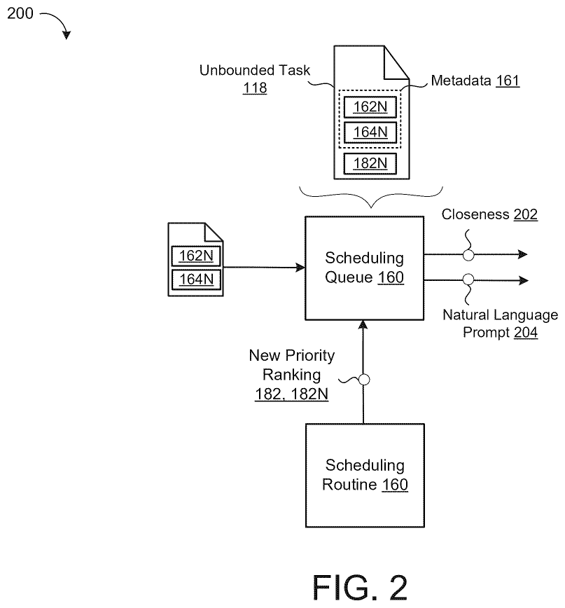

Referring now to FIG. 2, in some implementations, when the scheduler 200 determines that the new performance state 162N indicates that the LLM-powered assistant 150 has not reached the state of completion for solving the corresponding time unbounded task, the scheduler 200 updates the respective metadata 161 for the corresponding time unbounded task 118 in the scheduling queue 160 to designate the new performance state 162N obtained for the corresponding time unbounded task as the current performance state. Moreover, the scheduler 200 re-executes the scheduling routine 180 to assign a new respective priority ranking 182 to the corresponding time unbounded task 118 in the scheduling queue 160 by processing the respective metadata 161. In some examples, the scheduler 200 updates the respective metadata 161 by updating the respective metadata 161 for the corresponding time unbounded task 118 to include new triggering criteria 164N allocated or assigned to the corresponding unbounded task 118 based on the new performance state 162N obtained for the corresponding time unbounded task 118. Here, the scheduler 200 may determine a difference between the current performance state 162 and the new performance state 162N and update the respective metadata 161 based on the difference. As such, by updating the metadata 161 for the corresponding time unbounded task 118, the scheduler 200 may re-execute the scheduling routine 180 based on the updated metadata 161.

When the new performance state 162N indicates that the LLM-powered assistant 150 has not reached the state of completion, the scheduler 200 processes the new performance state 162N to estimate a closeness 202 indicating how close the corresponding time unbounded task 118 is to reaching the state of completion. The closeness 202 may indicate an estimated percentage of the time unbounded task 118 reaching completion. In some examples, the scheduler 200 may structure a natural language prompt 204 to solicit a response from the LLM-powered assistant 150 that indicates a level of completeness of the corresponding unbounded task 118. As such, the scheduler 200 may generate the natural language prompt 204 in addition to, or in lieu of, the estimated closeness 202.

Referring back to FIG. 1, the LLM-powered assistant 150 may identify one or more types of additional execution events 155 to perform in order to achieve improvements to the new performance state 162N based on the estimated closeness 202 of the corresponding time unbounded task 118 to reaching the state of completion and/or on the current performance state 162 of the corresponding time unbounded task 118. For instance, the LLM-powered assistant 150 may determine that the time unbounded task 118 is complete based on the estimated closeness 202 or determine that one or more additional execution events 155 are needed in order to reach a state of completion for the corresponding time unbounded task 118.

In some examples, in addition to, or in lieu of, receiving the estimated closeness 202, the LLM-powered assistant 150 processes the natural language prompt 204 and is conditioned on the new performance state 162N to determine the level of completeness of the corresponding time unbounded task 118. Similar to the estimated closeness 202, the level of completeness may indicate an estimated percentage of the time unbounded task 118 reaching completion. Alternatively, the level of completeness may indicate a quality estimate for an answer to the query 116. For instance, the new performance state 162N may indicate that the task is complete but of insufficient quality to be useful yet. Put another way, the performance state 162N may indicate that no additional execution events 155 currently need to be performed, but that the new performance state 162N is insufficient to answer the query 116. In these examples, the LLM-powered assistant 150 identifies one or more types of additional execution events 155 to perform to achieve improvements to the new performance state 162N based on the determined level of completeness and/or the current performance state of the corresponding time unbounded task 118. Moreover, the LLM-powered assistant 150 may determine that the corresponding time unbounded task 118 is complete based on the level of completeness determined based on processing the natural language prompt 204. Notably, the LLM-powered assistant 150 may be conditioned on the new performance state 162N while processing the natural language prompt 204.

In some implementations, after the LLM-powered assistant 150 performs the corresponding execution event 155 to obtain the new performance state 162N for a corresponding one of the multiple time unbounded tasks 118 in the scheduling queue 160, the task management system 105 determines that the new performance state 162N for the corresponding one of the multiple time unbounded tasks 118 effects the current performance state 162 of a corresponding other one of the multiple time unbounded tasks 118 in the scheduling queue 160. Thereafter, the task management system 105 updates at least one of the current performance state 162 or the triggering criteria 164 indicated by the respective metadata 161 for the corresponding other one of the multiple time unbounded tasks 118 in the scheduling queue 160 based on determining that the new performance state 162N for the corresponding one of the multiple time unbounded tasks 118 effects the current performance state 162 of a corresponding other one of the multiple time unbounded tasks 118 in the scheduling queue 160. Here, the LLM-powered assistant 150 may provide the notification 156 to the user 10 that indicates that the at least one of the current performance state 162 or the triggering criteria 164 indicated by the respective metadata 161 for the corresponding other one of the multiple time unbounded tasks 118 in the scheduling queue 160 has been updated.

After executing each execution event 155 for a corresponding time unbounded task 118, the LLM-powered assistant 150 may determine whether the corresponding time unbounded task 118 has reached a state of completion or not based on the results of executing the execution event 155. When the LLM-powered assistant 150 determines that the corresponding time unbounded task 118 has reached a state of completion, the LLM-powered assistant 150 generates a final result 158 based on the one or more previously executed execution events 155. In the example shown, the LLM-powered assistant 150 generates the final result 158 for the query 116 of “find me a new job” and presents the final result 158 of “here are the details for the jobs I found based on the latest job postings . . . ” as presentation content 175.

As discussed above, many digital assistants powered by LLMs are often used for one-shot queries, where users 10 expect immediate answers to queries. However, many real-world tasks, such as job searches, holiday planning, and finding good deals on products, are ongoing and do not have a clear endpoint. For instance, finding a good deal on a product today may not be as good as the deal tomorrow. Thus, these tasks can benefit from continuous refinement and updates as new information becomes available.

The task management system 105 addresses this problem by determining whether tasks 118 specified by each query 116 are time unbounded tasks or time bounded tasks. The task management system 105 may determine whether the task 118 is time unbounded or not either explicitly based on the query 116 or implicitly through a follow-up clarification step (e.g., user feedback 172). For example, a user 10 may ask, “find me a new job,” and the LLM-powered assistant 160 would recognize this as a task 118 that requires ongoing effort.

The LLM-powered assistant 150 may provide the initial results 152 and seek clarifications (e.g., user feedback 172) from the user 10 to better understand their preferences. For instance, in the case of planning a holiday, the LLM-powered assistant 150 might ask, “Are you looking for a beach holiday or a mountain holiday?” or “Are you interested in discounted flights?” using the notification 156 that solicits user feedback 172 from the user 10. Once the task 118 is identified as a time unbounded task 118, the LLM-powered assistant 150 adds the task 118 to the scheduling queue 160. The scheduling queue 160 stores metadata 161 associated with the task 118, including the current performance state 162 (e.g., the state of the LLM-powered assistant 150 processing the task 118), relevant data that needs periodic refreshing, and priority ranking 182 that help prioritize the task 118. Advantageously, the metadata 161 allows the LLM-powered assistant 150 to prioritize the tasks 118 in the scheduling queue 160 and to resume execution of the task 118 efficiently from where the LLM-powered assistant 150 left off.

The scheduling routine 180, powered by the scheduler 200 and/or the LLM-powered assistant 150, periodically assigns the priority rankings 182 to the tasks 118 in the scheduling queue 160 based on their importance (e.g., metadata 161) and the current processing load of the task management system 105. The LLM-powered assistant 150 may revisit tasks 118 periodically, updating the tasks 118 with new information and refining the results using self-critique techniques. For example, the LLM-powered assistant 150 may continuously monitor job postings or airline costs and update the user when relevant information is found. The task management system 105 also allows user feedback 172 and external events to trigger reprocessing of tasks 118. For instance, if a user 10 provides new salary expectations during a job search, the LLM-powered assistant 150 incorporates this information into the ongoing task 118. Similarly, external events like new job postings or price changes can prompt the LLM-powered assistant 150 to update the task 118.

The task management system 105 also supports distributed processing, where tasks 118 may be shared across multiple different LLM-powered assistants 150. This approach reduces costs and increases the diversity of solutions by allowing different LLM-powered assistants 150 to work on the task 118. Since time unbounded tasks 118 may not have a strict time constraint for generating an answer, the LLM-powered assistant 150 may perform the execution events 155 during off-peak cycles. That is, the LLM-powered assistant 150 may determine an optimal time to execute the execution events 155 based on the availability and/or costs of computing resources and schedule execution of the execution event 155 for the determined optimal time.

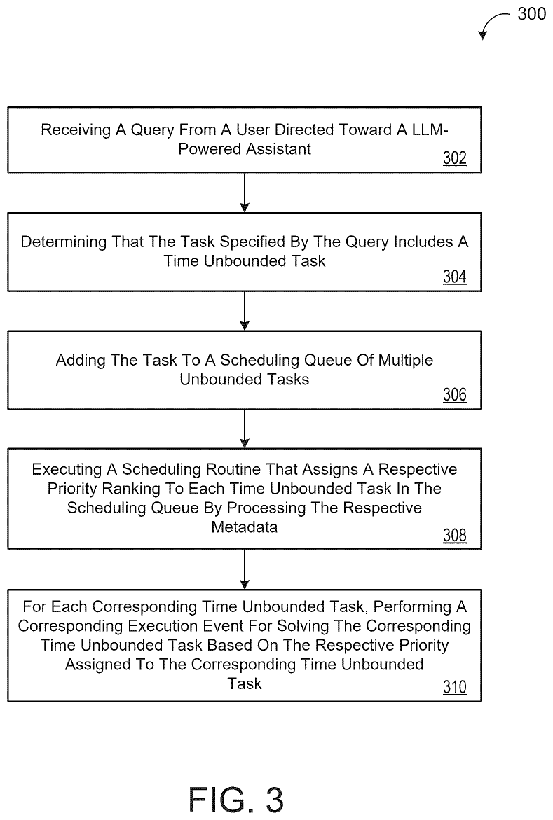

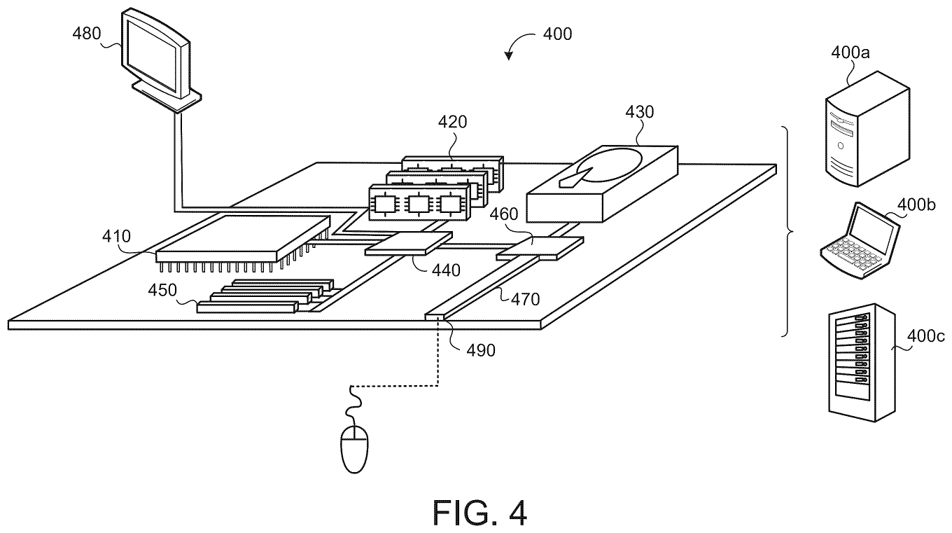

FIG. 3 illustrates a flowchart of an example flowchart of operations for a computer-implemented method 300 of executing long running background tasks. The method 300 may execute on data processing hardware 410 (FIG. 4) using instructions stored on memory hardware 420 (FIG. 4) that may reside on the user device 110 and/or the remote computing system 120 of FIG. 1 each corresponding to a computing device 400 (FIG. 4).

At operation 302, the method 300 includes receiving a query 116 from a user 10 directed toward a large language model (LLM)-powered assistant 150. The query 116 specifies a task 118 for the LLM-powered assistant 150 to solve or perform on behalf of the user 10. At operation 304, the method 300 includes determining that the task 118 specified by the query 116 includes a time unbounded task 118 that benefits from being continuously solved during ongoing execution events 155 performed by the LLM-powered assistant 150. At operation 306, the method 300 includes adding the task 118 to a scheduling queue 160 of multiple time unbounded tasks 118 based on determining that the task 118 specified by the query 116 includes the time unbounded task 118. Each corresponding time unbounded task 118 among the multiple time unbounded tasks 118 in the scheduling queue 160 including respective metadata 161 that indicates a current performance state 162 of the corresponding time unbounded task 118 performed by the LLM-powered assistant 150 and triggering criteria 164 allocated to the corresponding time unbounded task 118 that indicates when and/or how often the LLM-powered assistant 150 is to perform execution events 155 for solving the corresponding time unbounded task 118. At operation 308, the method 300 includes executing a scheduling routine 180 that assigns a respective priority ranking 181 to each time unbounded task 118 in the scheduling queue 160 by processing the respective metadata 161. At operation 310, the method 300 includes performing, by the LLM-powered assistant 150, a corresponding execution event 155 for solving the corresponding time unbounded task 118 at a respective time based on the respective priority ranking 182 assigned to the corresponding time unbounded task 118 to obtain a new performance state 162N of the corresponding time unbounded task 118 for each corresponding time unbounded task 118 of the multiple time unbounded tasks 118 in the scheduling queue 160.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410, memory 420, a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor (e.g., data processing hardware) 410 can process instructions for execution within the computing device 400, including instructions stored in the memory 420 or on the storage device 430 to display graphical information for a graphical user interface (GUI) on an external input/output device, such as display 480 coupled to high speed interface 440, In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system). The data processing hardware 410 may include the data processing hardware 113 of the user device 110 and/or the data processing hardware 123 of the remote computing system 120.

The memory (e.g., memory hardware) 420 stores information non-transitorily within the computing device 400. The memory hardware 420 may include the memory hardware 114 of the user device 110 and/or the memory hardware 124 of the remote computing system 120. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks, The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
receiving a query from a user directed toward a large language model (LLM)-powered assistant, the query specifying a task for the LLM-powered assistant to solve on behalf of the user;
determining that the task specified by the query comprises a time unbounded task that benefits from being continuously solved during ongoing execution events performed by the LLM-powered assistant;
based on determining that the task specified by the query comprises the time unbounded task, adding the task to a scheduling queue of multiple time unbounded tasks, each corresponding time unbounded task among the multiple time unbounded tasks in the scheduling queue comprising respective metadata that indicates:
a current performance state of the corresponding time unbounded task performed by the LLM-powered assistant; and
triggering criteria allocated to the corresponding time unbounded task that indicates when and/or how often the LLM-powered assistant is to perform execution events for solving the corresponding time unbounded task;
executing a scheduling routine that assigns a respective priority ranking to each time unbounded task in the scheduling queue by processing the respective metadata; and
for each corresponding time unbounded task of the multiple time unbounded tasks in the scheduling queue, performing, by the LLM-powered assistant, to obtain a new performance state of the corresponding time unbounded task, a corresponding execution event for solving the corresponding time unbounded task at a respective time based on the respective priority assigned to the corresponding time unbounded task.

2. The method of claim 1, wherein the operations further comprise:
in response to receiving the query:
obtaining initial results responsive to an initial attempt by the LLM-powered assistant to solve the task specified by the query; and
serving the initial results to the user; and
after serving the initial results to the user, receiving user feedback indicating that the user would like the LLM-powered assistant to better solve the task specified by the query without specifying any time bound to solve the task,
wherein determining that the task specified by the query comprises the time unbounded task based on the received user feedback.

3. The method of claim 1, wherein the operations further comprise:
after adding the task to the scheduling queue of the multiple time unbounded tasks, processing, by the LLM-powered assistant, the task specified by the query to predict a code script useful for triggering the LLM-powered assistant to perform an execution event for solving the task;
attaching the predicted code script to the respective metadata of the task added to the scheduling queue;
executing the code script to check whether content relevant to solving the task becomes available at one or more external content sources; and
when the content relevant to solving the task becomes available at one of the one or more external content sources, re-executing the scheduling routine to assign a new priority ranking to the task in the scheduling queue.

4. The method of claim 1, wherein the operations further comprise, after performing the corresponding execution event for solving the corresponding time unbounded task to obtain the new performance state:
determining whether the new performance state obtained for the corresponding time unbounded task indicates that the LLM-powered assistant has reached a state of completion for solving the corresponding time unbounded task; and
when the new performance state indicates that the LLM-powered assistant has not reached the state of completion for solving the corresponding time unbounded task:
updating the respective metadata for the corresponding time unbounded task in the scheduling queue to designate the new performance state obtained for the corresponding time unbounded task as the current performance state; and
re-executing the scheduling routine to assign a new respective priority ranking to the corresponding time unbounded task in the scheduling queue by processing the respective metadata.

5. The method of claim 4, wherein updating the respective metadata further comprises updating the respective metadata for the corresponding time unbounded task to include new triggering criteria allocated to the corresponding unbounded task based on the new performance state obtained for the corresponding time unbounded task.

6. The method of claim 4, wherein the operations further comprise, when the new performance state indicates that the LLM-powered assistant has not reached the state of completion:
processing the new performance state to estimate how close the corresponding time unbounded task is to reaching the state of completion; and
based on the estimated closeness of the corresponding time unbounded task to reaching the state of completion, identifying, by the LLM-powered assistant, based on the current performance state of the corresponding time unbounded task, one or more types of additional execution events to perform to achieve improvements to the new performance state.

7. The method of claim 6, wherein processing the new performance state to estimate how close the corresponding time unbounded task is to reaching the state of completion comprises:
structuring a natural language prompt to solicit a response from the LLM-powered assistant that indicates a level of completeness of the corresponding unbounded task; and
processing, using the LLM-powered assistant, the natural language prompt conditioned on the new performance state to determine the level of completeness of the corresponding time unbounded task.

8. The method of claim 4, wherein the operations further comprise, when the new performance state indicates that the LLM-powered assistant has not reached the state of completion:
determining, based on the new performance state, that it would be beneficial to solicit additional information from the user regarding the new performance state of the corresponding time unbounded task;
issuing a notification to the user, the notification indicating the new performance state of the corresponding time unbounded task and soliciting the user to provide the additional information regarding the new performance state of the corresponding time unbounded task;
receiving the additional information from the user regarding the new performance state of the corresponding unbounded task; and
based on the received additional information from the user, performing, by the LLM-powered assistant, another corresponding execution event for solving the corresponding time unbounded task to update the new performance state.

9. The method of claim 1, wherein the respective metadata further indicates time-stamped data obtained by the LLM-powered assistant during one or more previous execution events of the corresponding time unbounded task performed by the LLM-powered assistant.

10. The method of claim 1, wherein the operations further comprise:
receiving contextual information related to the user and/or one or more external events associated with at least one of the time unbounded tasks in the scheduling queue of the multiple time unbounded tasks; and
based on the received contextual information, re-executing the scheduling routine to update the respective priority ranking assigned to each time unbounded task in the scheduling queue.

11. The method of claim 1, wherein the operations further comprise, after performing the corresponding execution event to obtain the new performance state for a corresponding one of the multiple time unbounded tasks in the scheduling queue:
determining that the new performance state for the corresponding one of the multiple time unbounded tasks effects the current performance state of a corresponding other one of the multiple time unbounded tasks in the scheduling queue; and
based on determining that the new performance state for the corresponding one of the multiple time unbounded tasks effects the current performance state of the corresponding other one of the multiple time unbounded tasks in the scheduling queue, updating at least one of the current performance state or the triggering criteria indicated by the respective metadata for the corresponding other one of the multiple time unbounded tasks in the scheduling queue.

12. The method of claim 11, wherein the operations further comprising providing a notification to the user that indicates that the at least one of the current performance state or the triggering criteria indicated by the respective metadata for the corresponding other one of the multiple time unbounded tasks in the scheduling queue has been updated.

13. A system comprising:
data processing hardware; and
memory hardware in communication with the data processing hardware, the memory hardware storing instructions that when executed on the data processing hardware cause the data processing hardware to perform operations comprising:
receiving a query from a user directed toward a large language model (LLM)-powered assistant, the query specifying a task for the LLM-powered assistant to solve on behalf of the user;
determining that the task specified by the query comprises a time unbounded task that benefits from being continuously solved during ongoing execution events performed by the LLM-powered assistant;
based on determining that the task specified by the query comprises the time unbounded task, adding the task to a scheduling queue of multiple time unbounded tasks, each corresponding time unbounded task among the multiple time unbounded tasks in the scheduling queue comprising respective metadata that indicates:
a current performance state of the corresponding time unbounded task performed by the LLM-powered assistant; and
triggering criteria allocated to the corresponding time unbounded task that indicates when and/or how often the LLM-powered assistant is to perform execution events for solving the corresponding time unbounded task;
executing a scheduling routine that assigns a respective priority ranking to each time unbounded task in the scheduling queue by processing the respective metadata, and
for each corresponding time unbounded task of the multiple time unbounded tasks in the scheduling queue, performing, by the LLM-powered assistant, to obtain a new performance state of the corresponding time unbounded task, a corresponding execution event for solving the corresponding time unbounded task at a respective time based on the respective priority assigned to the corresponding time unbounded task.

14. The system of claim 13, wherein the operations further comprise:
in response to receiving the query:
obtaining initial results responsive to an initial attempt by the LLM-powered assistant to solve the task specified by the query; and
serving the initial results to the user; and
after serving the initial results to the user, receiving user feedback indicating that the user would like the LLM-powered assistant to better solve the task specified by the query without specifying any time bound to solve the task,
wherein determining that the task specified by the query comprises the time unbounded task based on the received user feedback.

15. The system of claim 13, wherein the operations further comprise:
after adding the task to the scheduling queue of the multiple time unbounded tasks, processing, by the LLM-powered assistant, the task specified by the query to predict a code script useful for triggering the LLM-powered assistant to perform an execution event for solving the task;
attaching the predicted code script to the respective metadata of the task added to the scheduling queue;
executing the code script to check whether content relevant to solving the task becomes available at one or more external content sources; and
when the content relevant to solving the task becomes available at one of the one or more external content sources, re-executing the scheduling routine to assign a new priority ranking to the task in the scheduling queue.

16. The system of claim 13, wherein the operations further comprise, after performing the corresponding execution event for solving the corresponding time unbounded task to obtain the new performance state:
determining whether the new performance state obtained for the corresponding time unbounded task indicates that the LLM-powered assistant has reached a state of completion for solving the corresponding time unbounded task; and
when the new performance state indicates that the LLM-powered assistant has not reached the state of completion for solving the corresponding time unbounded task:
updating the respective metadata for the corresponding time unbounded task in the scheduling queue to designate the new performance state obtained for the corresponding time unbounded task as the current performance state; and
re-executing the scheduling routine to assign a new respective priority ranking to the corresponding time unbounded task in the scheduling queue by processing the respective metadata.

17. The system of claim 16, wherein updating the respective metadata further comprises updating the respective metadata for the corresponding time unbounded task to include new triggering criteria allocated to the corresponding unbounded task based on the new performance state obtained for the corresponding time unbounded task.

18. The system of claim 16, wherein the operations further comprise, when the new performance state indicates that the LLM-powered assistant has not reached the state of completion:
processing the new performance state to estimate how close the corresponding time unbounded task is to reaching the state of completion; and
based on the estimated closeness of the corresponding time unbounded task to reaching the state of completion, identifying, by the LLM-powered assistant, based on the current performance state of the corresponding time unbounded task, one or more types of additional execution events to perform to achieve improvements to the new performance state.

19. The system of claim 18, wherein processing the new performance state to estimate how close the corresponding time unbounded task is to reaching the state of completion comprises:
structuring a natural language prompt to solicit a response from the LLM-powered assistant that indicates a level of completeness of the corresponding unbounded task; and
processing, using the LLM-powered assistant, the natural language prompt conditioned on the new performance state to determine the level of completeness of the corresponding time unbounded task.

20. The system of claim 16, wherein the operations further comprise, when the new performance state indicates that the LLM-powered assistant has not reached the state of completion:
determining, based on the new performance state, that it would be beneficial to solicit additional information from the user regarding the new performance state of the corresponding time unbounded task;
issuing a notification to the user, the notification indicating the new performance state of the corresponding time unbounded task and soliciting the user to provide the additional information regarding the new performance state of the corresponding time unbounded task;
receiving the additional information from the user regarding the new performance state of the corresponding unbounded task; and
based on the received additional information from the user, performing, by the LLM-powered assistant, another corresponding execution event for solving the corresponding time unbounded task to update the new performance state,

21. The system of claim 13, wherein the respective metadata further indicates time-stamped data obtained by the LLM-powered assistant during one or more previous execution events of the corresponding time unbounded task performed by the LLM-powered assistant.

22. The system of claim 13, wherein the operations further comprise:
receiving contextual information related to the user and/or one or more external events associated with at least one of the time unbounded tasks in the scheduling queue of the multiple time unbounded tasks; and
based on the received contextual information, re-executing the scheduling routine to update the respective priority ranking assigned to each time unbounded task in the scheduling queue.

23. The system of claim 13, wherein the operations further comprise, after performing the corresponding execution event to obtain the new performance state for a corresponding one of the multiple time unbounded tasks in the scheduling queue:
determining that the new performance state for the corresponding one of the multiple time unbounded tasks effects the current performance state of a corresponding other one of the multiple time unbounded tasks in the scheduling queue; and
based on determining that the new performance state for the corresponding one of the multiple time unbounded tasks effects the current performance state of the corresponding other one of the multiple time unbounded tasks in the scheduling queue, updating at least one of the current performance state or the triggering criteria indicated by the respective metadata for the corresponding other one of the multiple time unbounded tasks in the scheduling queue.

24. The system of claim 23, wherein the operations further comprising providing a notification to the user that indicates that the at least one of the current performance state or the triggering criteria indicated by the respective metadata for the corresponding other one of the multiple time unbounded tasks in the scheduling queue has been updated.
